(19) United States
(12) Patent Application Publication
(10) Pub. No.: US 2008/0061927 A1
(43) Pub. Date: Mar. 13, 2008

(54) BIOMETRIC LOCKSET

(76) Inventor: Russell Hurbert Manton, Morrill, ME (US)

Correspondence Address: ROBERT D. GUNDERMAN, JR.;PATENT TECHNOLOGIES, LLC, 150 LUCIUS GORDON DRIVE, SUITE 205, WEST HENRIETTA, NY, 14586, US

(21) Appl. No.: 11/466,422

(22) Filed: Aug. 22, 2006

(51) Int. Cl. G06K 9/00

(52) U.S. Cl. 340/5.53; 382/124; 340/5.7; 340/5.54

(57) ABSTRACT

A biometric lockset is provided which includes a lockset body containing control circuitry wherein the control circuitry is operatively coupled to a fingerprint sensor, a motor driven by the control circuitry and mechanically coupled to the lockset body, and a slideway for covering the fingerprint sensor wherein the slideway contains a switch for activating the fingerprint sensor and control circuitry upon opening of the slideway to expose the fingerprint sensor. The biometric lockset is protected from environmental damage by the novel slideway mechanism, which further provides power management functionality to the biometric lockset.

### BACKGROUND OF THE INVENTION

1. Field of the Invention

This invention relates generally to locksets, and more particularly to a biometric lockset.

2. Description of Related Art

The related art has disclosed various devices for locking a door. Frequently, a door is secured using a lockset that contains a mechanical lock requiring a key for access. The use of a key, while extremely common, is prone to several inconveniences. A lost key, for example, represents not only a potential security problem, but a hardship for the owner of the key who must either seek out a duplicate key, request the assistance of a locksmith, or replace the lock entirely. A key also may be inconvenient to store and retrieve for use. Further, multiple keys may also be difficult to use and store.

The ability to secure a door without the use of a key has heretofore been possible by the use of a combination lock that requires the entry of a specific series of numbers for access. This eliminates the difficulties that are associated with a key, but requires the user to memorize the specific series of numbers or retrieve the series of numbers from an inscription.

The use of a biometric sensor in a lockset, such as that disclosed in U.S. Pat. No. 5,701,770 to Cook et al, would represent a tremendous improvement in convenience and ease of use over a keyed lockset as well as a combination lockset. Unfortunately, the harsh environment of most locksets makes it difficult to use a biometric sensor successfully in such an application. Sun, rain, drastic temperature changes, snow, ice, environmental pollutants, harsh use and abuse, all represent unmet technical challenges. It is an object of the present invention to provide a biometric lockset that contains a slideway for protecting the biometric lockset from environmental damage. It is another object of the present invention to provide a biometric lockset with multiple access methods, including biometric access, keypad access, and mechanical keyway access. It is another object of the present invention to provide a biometric lockset that can be unlocked with multiple access methods, including biometric verification, keypad verification, mechanical keyway, and inside handle action. It is a further object of the present invention to provide a biometric lockset that can be placed in passage mode using biometric triggering, keypad entry, inside handle action, or switch placement. It is yet another object of the present invention to provide a biometric lockset that can be placed in privacy mode with a keypad entry.

### BRIEF SUMMARY OF THE INVENTION

In accordance with the present invention, there is provided a biometric lockset comprising a lockset body containing control circuitry wherein the control circuitry is operatively coupled to a fingerprint sensor; a motor driven by the control circuitry and mechanically coupled to the lockset body; and a slideway for covering the fingerprint sensor wherein the slideway contains a switch for activating the fingerprint sensor and control circuitry upon opening of the slideway to expose the fingerprint sensor.

The foregoing paragraph has been provided by way of introduction, and is not intended to limit the scope of the following claims.

### BRIEF DESCRIPTION OF THE DRAWINGS

The invention will be described by reference to the following drawings, in which like numerals refer to like elements, and in which:

FIG. 1 is a perspective view of the Biometric Lockset;

FIG. 2 is a front plan view of the Biometric Lockset;

FIG. 3 is a view of the Biometric Lockset with the slideway open;

FIG. 4 is a left side elevation view of the Biometric Lockset;

FIG. 5 is a right side elevation view of the Biometric Lockset;

FIG. 6 is a bottom view of the Biometric Lockset;

FIG. 7 is a block diagram of the electronics of the Biometric Lockset;

FIG. 8 is an exemplary electrical schematic of the Biometric Lockset;

FIG. 9 is a flowchart showing a method of changing the master code of the Biometric Lockset;

FIG. 10 is a flowchart showing a method of adding one PIN user to the Biometric Lockset;

FIG. 11 is a flowchart showing a method of adding multiple PIN users to the Biometric Lockset;

FIG. 12 is a flowchart showing a method of adding a temporary PIN user to the Biometric Lockset;

FIG. 13 is a flowchart showing a method of deleting one PIN user from the Biometric Lockset;

FIG. 14 is a flowchart showing a method of deleting all PIN users from the Biometric Lockset;

FIG. 15 is a flowchart showing a method of changing a PIN number in the Biometric Lockset;

FIG. 16 is a flowchart showing a method of entering a single fingerprint into the Biometric Lockset;

FIG. 17 is a flowchart showing a method of entering multiple fingerprints into the Biometric Lockset;

FIG. 18 is a flowchart showing a method of deleting one fingerprint user from the Biometric Lockset;

FIG. 19 is a flowchart showing a method of deleting all fingerprint users from the Biometric Lockset;

FIG. 20 is a flowchart showing a method of setting the Biometric Lockset into Passage Mode; and

FIG. 21 is a flowchart showing a method of setting the Biometric Lockset into Privacy Mode.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by this specification and the appended claims.

### DESCRIPTION OF THE PREFERRED EMBODIMENTS

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

For a general understanding of the present invention, reference is made to the drawings. In the drawings, like reference numerals have been used throughout to designate identical elements.

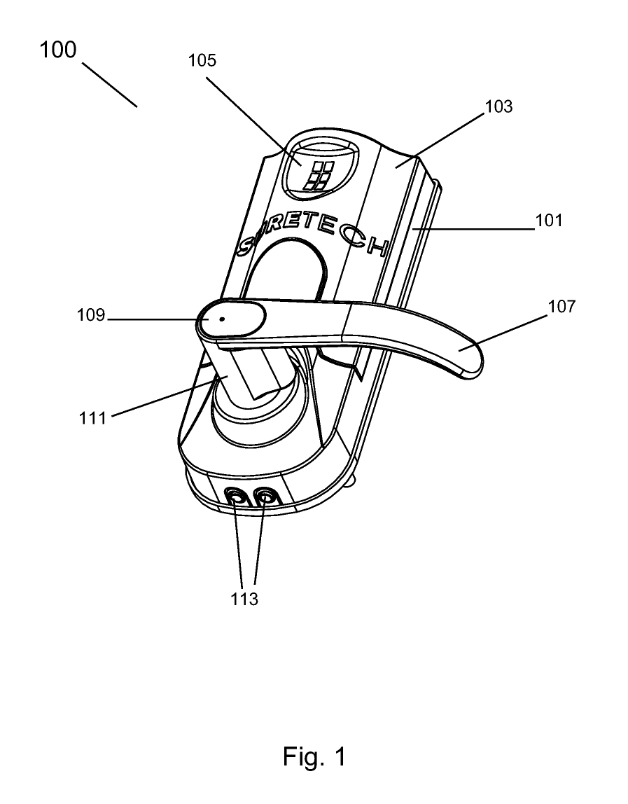

FIG. 1 is a perspective view of the biometric lockset. Referring to FIG. 1, the biometric lockset 100 is depicted with the slideway 103 in the closed position. The slideway 103 serves to provide protection to the electronics and sensors that are required for biometric identity verification. The biometric lockset 100 may be placed on any interior or exterior door where the owner is desirous of securing the passageway of such door. The biometric lockset 100 may be installed on new doors, or may be used to replace existing locksets. The biometric lockset body 101 and slideway 103 are made from a metal such as chrome plated steel, stainless steel, brass, brass plated steel, or any other material that may be used to manufacture door locksets, as known to those skilled in the art. The slideway 103 may, in some embodiments of the present invention, contain a slideway indent 105 that provides a convenient finger or thumb retention point, facilitating movement of the slideway 103. The slideway 103 may be raised upward to allow access to the keypad and biometric platen (not shown). The slideway 103 is often left in the down position when the lockset is not in use, to provide environmental protection to the internal electronics. The biometric lockset 100 further contains a lockset shaft 111 that mechanically connects the outer handle 107 to the inner latch assembly and latch (not shown). The biometric lockset 107 installs by conventional means with a strike plate located on a door jamb, a latch plate mortise, and a face bore and backset, as is known to those skilled in the art. The biometric lockset 100 contains a mechanical keyway that provides an override to the electronics, the mechanical keyway being covered by a keyway cover 109 during normal operation. Also shown in FIG. 1 are external battery terminals 113 that allow the biometric lockset 100 to be powered by an external power source such as a nine volt battery, in the event that the internal batteries become depleted.

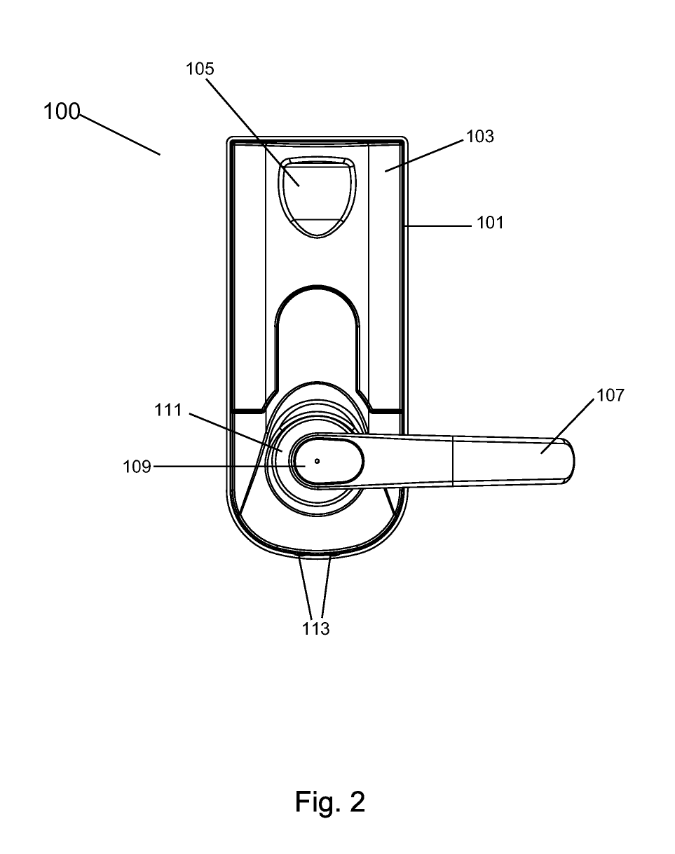

Referring now to FIG. 2, a front plan view of the Biometric Lockset 100 is shown. Again, the slideway 103 is depicted in the closed position.

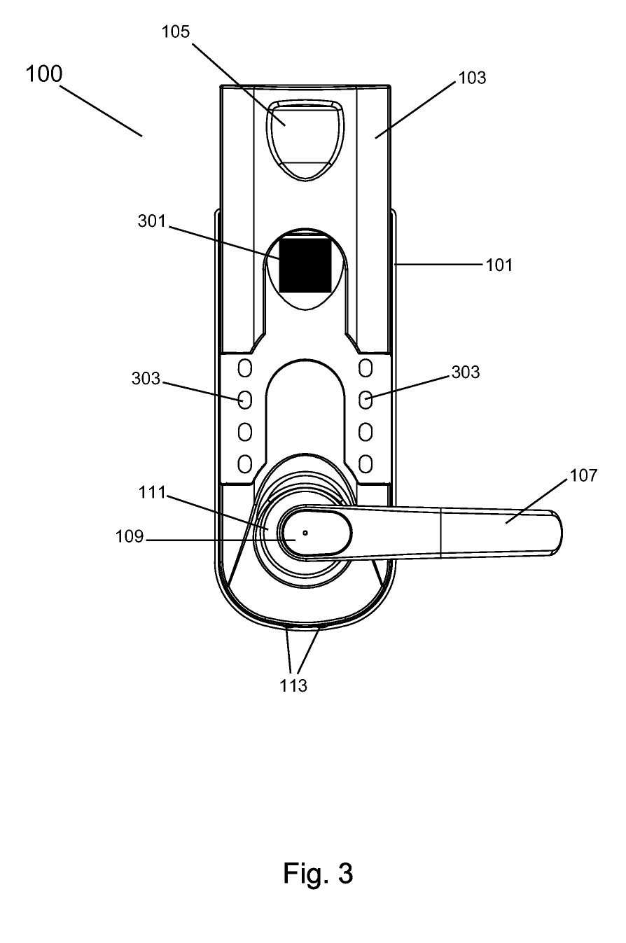

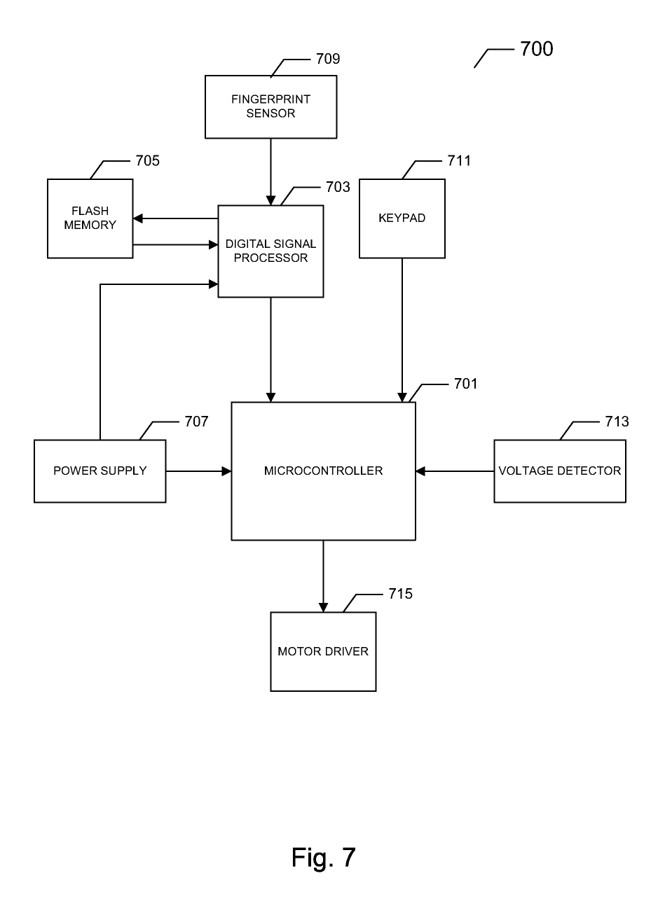

FIG. 3 shows a view of the Biometric Lockset 100 with the slideway 103 open. The slideway 103, when open, exposes the platen 301 and the (alpha)numeric keypad 303. The platen 301 makes up the fingerprint sensor, which will be further described by way of FIG. 7 of this specification. The platen 301 and overall fingerprint sensor may use optical technology, silicon technology, ultrasound technology, capacitive technology, or other biometric sensor technologies that are known to those skilled in the art. Optical technology, for example, is the oldest form of finger scan technology that uses a coated platen made of glass or hard plastic with a camera that registers the image of the fingerprint against the platen, with the fingerprint ridges and valleys being imaged by the camera, and the underlying software providing for assessment of fingerprint quality and generation of templates for enrollment or verification. Silicon technology may also be used in the fingerprint sensor of the present invention. Silicon technology uses a silicon chip as a platen, using the capacitive characteristics of fingerprint ridges and valleys for image acquisition. Silicon technologies may use, for example, active capacitance, which generates a small field that extends beyond the surface of the platen to the skin, as well as passive capacitance, which measures up to the point of contact. Ultrasound technology transmits inaudible acoustic waves to the finger, generating images by measuring the impedance between the finger, the platen, and air. Other technologies for biometric finger scan imaging include thermal imaging and pressure based sensors. The biometric lockset of the present invention may be locked and unlocked through three methods. First, the platen 301 can be used to recognize a fingerprint by way of the fingerprint sensor and related electronics. If the correct individual's identity can be verified, the biometric lockset will unlock. Second, the biometric lockset may be unlocked by way of the (alpha)numeric keypad 303. Third, the biometric lockset may be unlocked by way of a mechanical keyway that is covered by a keyway cover 109 as shown in FIG. 3.

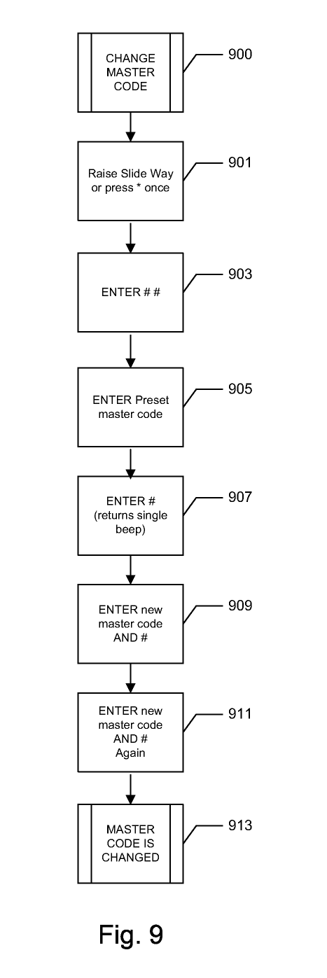

The (alpha)numeric keypad 303 serves not only to provide a means to unlock the biometric lock, but also serves to provide a programming interface to the biometric lockset. Various commands can be initiated from the (alpha)numeric keypad 303, as will be further described by way of FIGS. 9 through 21 and the associated descriptions.

The slideway 103 actuates a switch (not shown) that will “wake up” the biometric lockset, activating power to the electronics and the fingerprint sensor of the biometric lockset. In some embodiments of the present invention, the switch may be magnetic. This “wakeup” functionality provides for conservation of limited battery power within the lockset, thus reducing the required frequency of battery changes. The slideway 103 may also, in some embodiments of the present invention, contain a weather resistant seal placed between the slideway and the lockset body. The weather resistant seal may be in the form of a metal flashing, a rubber gasket, a flange, or any other sealing technique known to those skilled in the art.

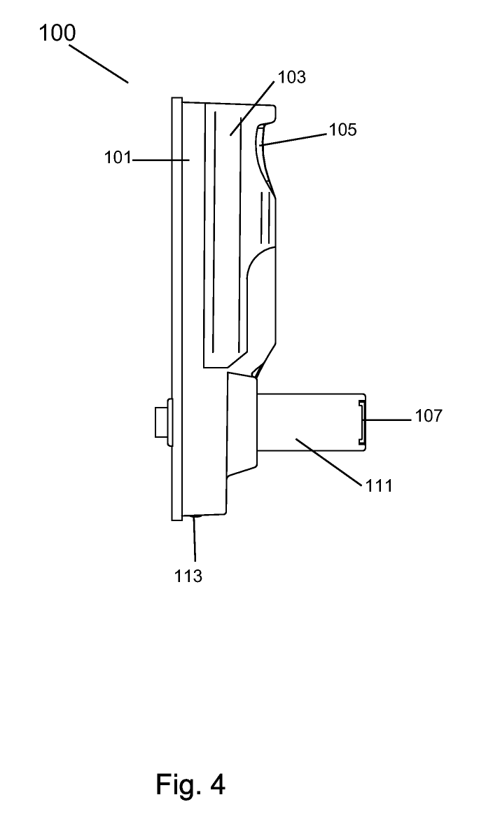

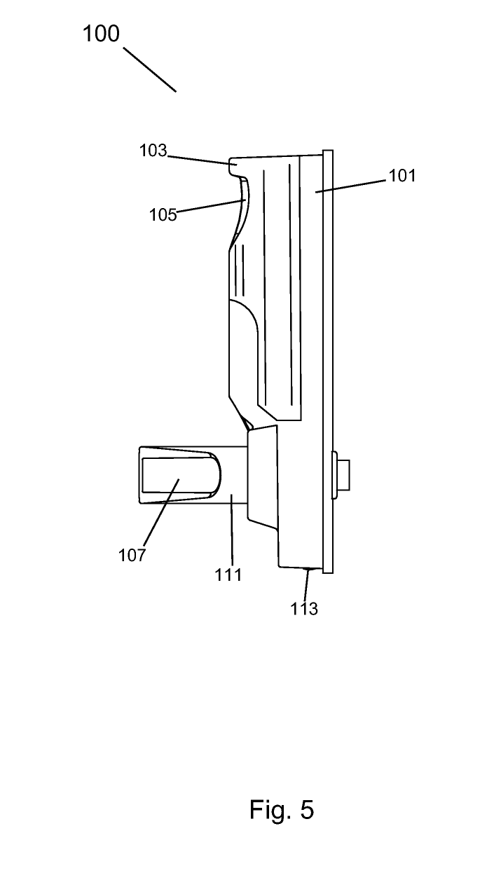

Turning now to FIG. 4, a left side elevation view of the Biometric Lockset 100 is shown. From the drawing, the slideway 103 can be seen in the closed position in relation to the lockset body 101. The slideway indent 105 is also visible, along with the outer handle 107, the lockset shaft 111, and the external battery terminals 113. FIG. 5 shows, in a similar manner, a right side elevation view of the Biometric Lockset 100.

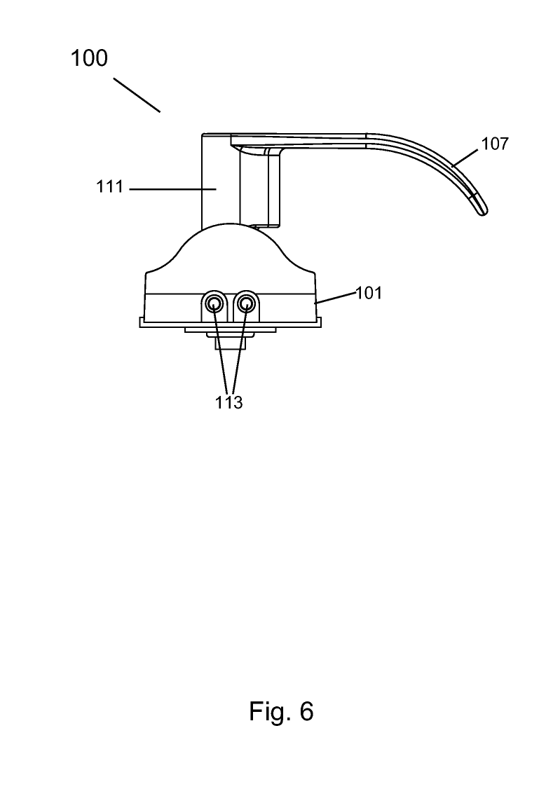

Referring now to FIG. 6, a bottom view of the Biometric Lockset 100 is depicted, showing clearly the external battery terminals 113. The external battery terminals 113 allow the biometric lockset 100 to be powered by an external power source such as a nine volt battery, in the event that the internal batteries become depleted.

The logic and control of the biometric lockset are performed using internal electronics, a block diagram of which is depicted in FIG. 7. FIG. 7 shows a microcontroller 701. A microcontroller suitable for use in the biometric lockset is a low power microcontroller, such as the MSP430F1111A manufactured by Texas Instruments. The microcontroller contains control logic software to control the operations of the biometric lockset. The MSP430F1111A microcontroller is a 16 bit ultra low power microcontroller, with 2 Kb of internal Flash Memory and 128B RAM, using a 16 bit RISC architecture. It operates under a low supply voltage range of 1.8 Volts to 3.6 Volts, making it suitable for a power supply containing AA size batteries. A digital Signal Processor 703 such as the Texas Instruments TMS320VC5416 contains the software algorithms to enroll and validate fingerprints that are sensed through the fingerprint sensor 709. The fingerprint sensor 709 may use optical technology, silicon technology, ultrasound technology, capacitive technology, or other biometric sensor technologies that are known to those skilled in the art. Optical technology, for example, is the oldest form of finger scan technology that uses a coated platen made of glass or hard plastic with a camera that registers the image of the fingerprint against the platen, with the fingerprint ridges and valleys being imaged by the camera and underlying software providing for assessment of fingerprint quality and generation of templates for enrollment or verification. Silicon technology may also be used in the fingerprint sensor of the present invention. Silicon technology uses a silicon chip as a platen, using the capacitive characteristics of fingerprint ridges and valleys for image acquisition. Silicon technologies may use, for example, active capacitance, which generates a small field that extends beyond the surface of the platen to the skin, as well as passive capacitance, which measures up to the point of contact. Ultrasound technology transmits inaudible acoustic waves to the finger, generating images by measuring the impedance between the finger, the platen, and air. Other technologies for biometric finger scan imaging include thermal imaging and pressure based sensors.

The Digital Signal Processor 703 is connected to external flash memory 705. An example of suitable flash memory is the SST39VF320, manufactured by SST Electronics. The SST39VF320 is a 2Mx16 CMOS multi-purpose flash memory module that uses a 2.7 volt to 3.6 volt power supply.

Connected to the microcontroller 701 is a keypad 711 that provides a user interface to the microcontroller 701. The keypad may be used to enter a valid security code to open the biometric lock, or to provide instructions to the biometric lockset, such as those described by way of FIGS. 9 through 21.

A power supply 707, such as AA size batteries, powers the microcontroller 701, the digital signal processor 703, and related electronics. A motor driver 715 is connected to the microcontroller 701 and serves to operate the actuator motor that drives the mechanical locking mechanism of the biometric lockset. A voltage detector 713 interfaces with the microcontroller 701 and senses voltage threshold conditions such as low battery voltage, providing a flag to the microcontroller 701 to sound an audible alert.

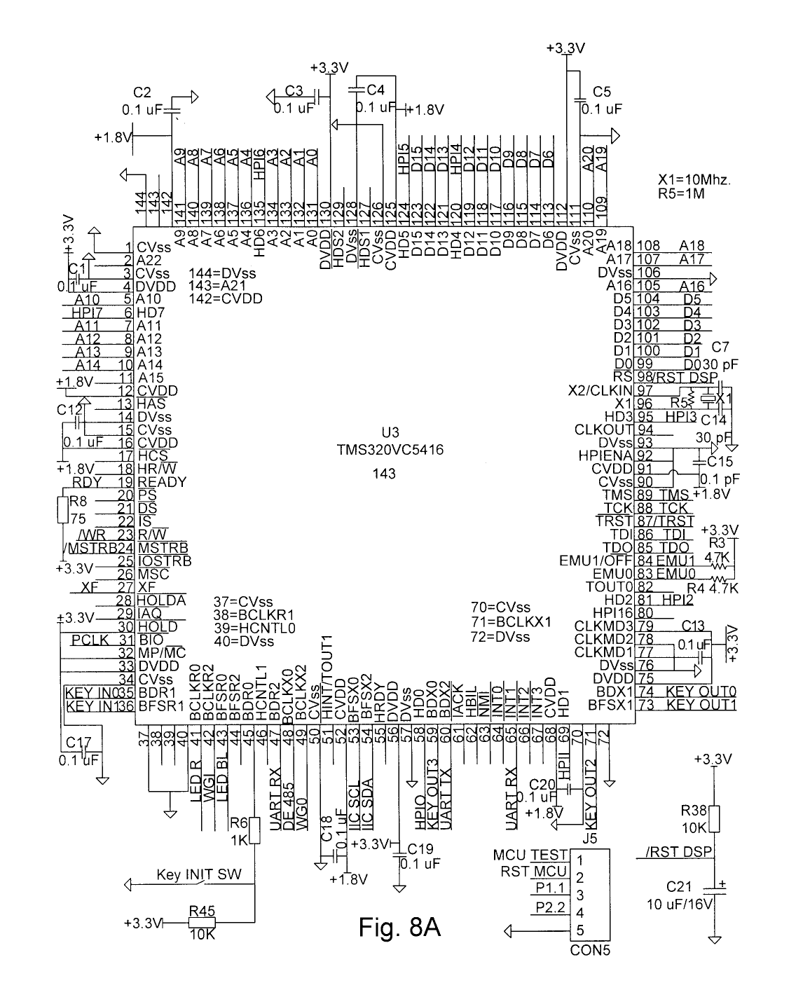

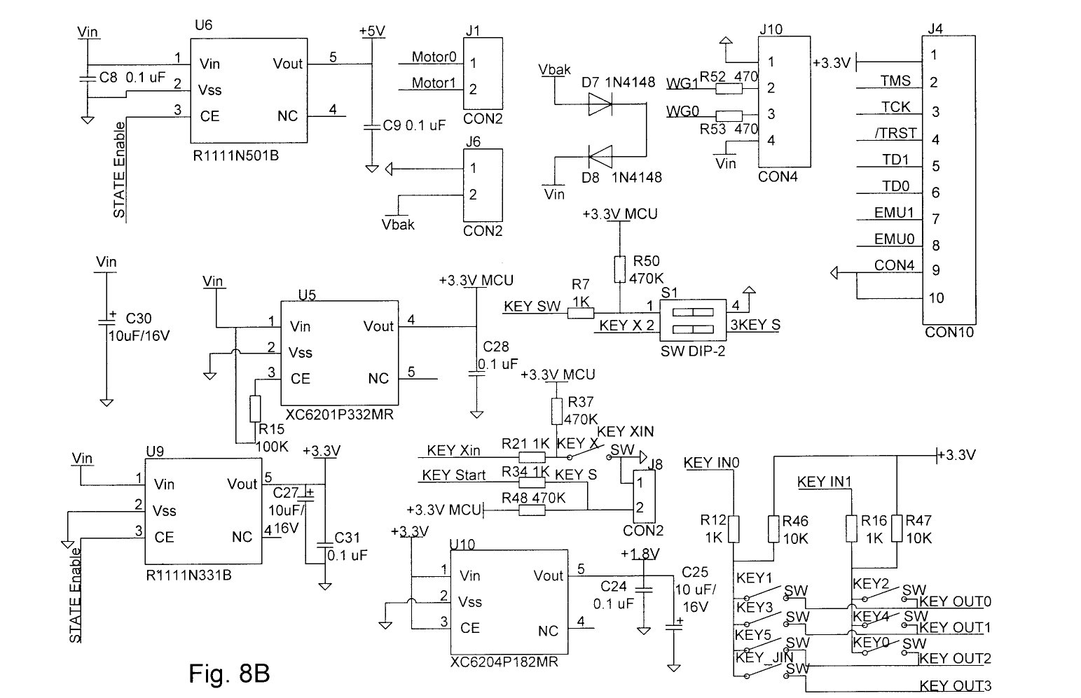

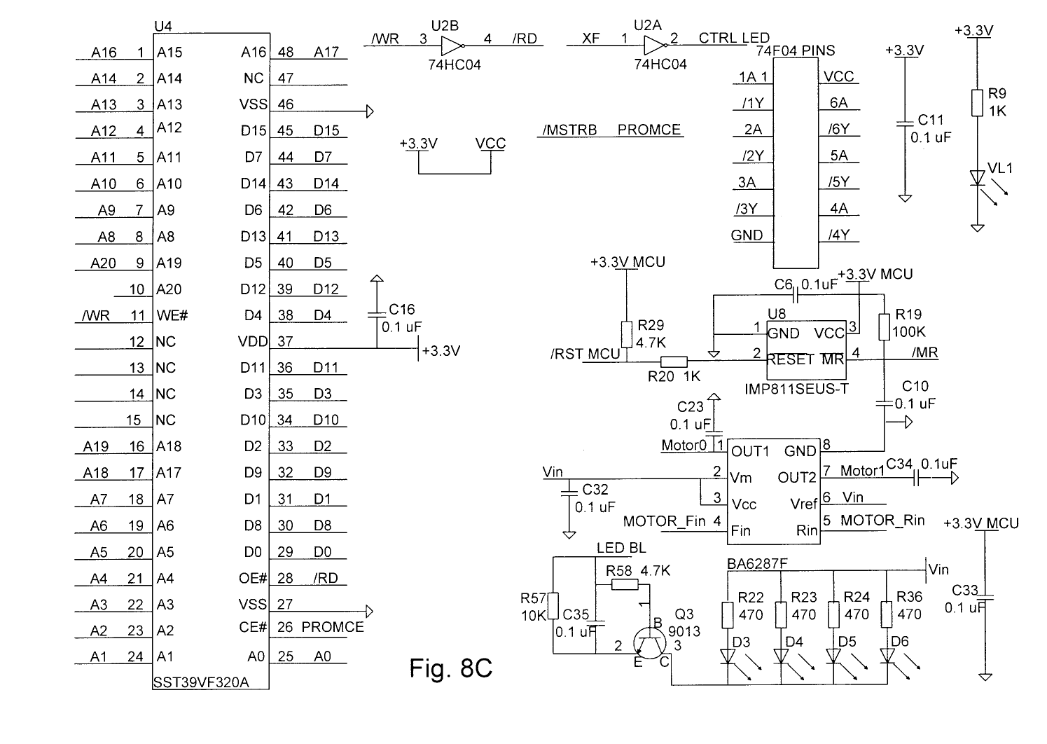

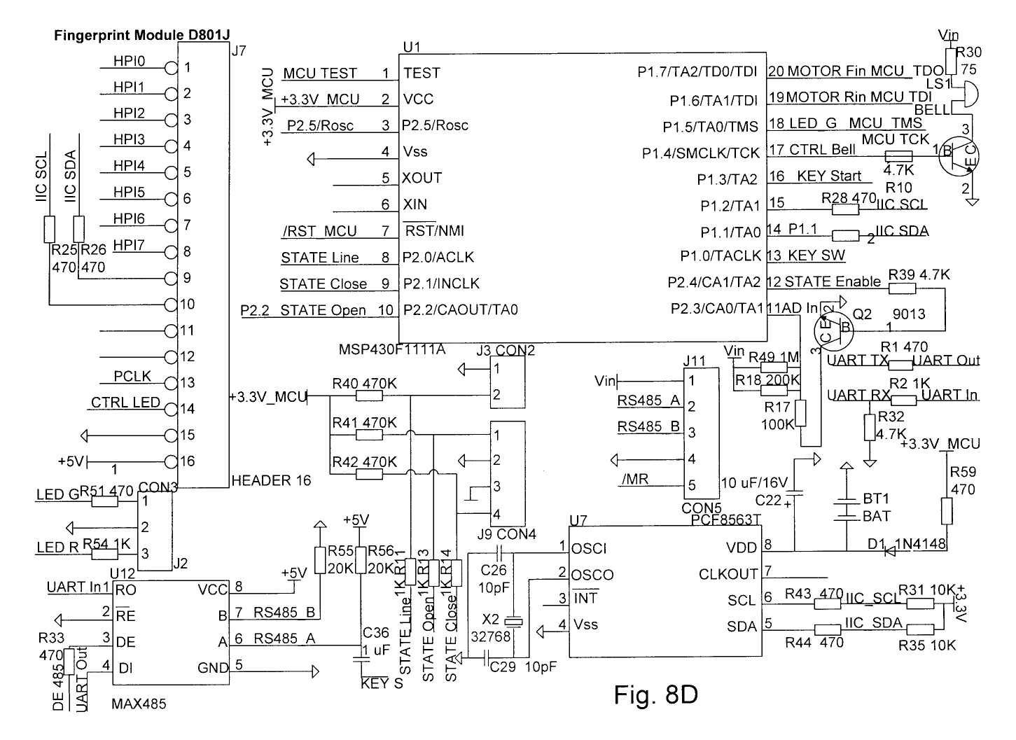

Referring now to FIG. 8, an exemplary electrical schematic of the biometric lockset of the present invention is shown. The schematic depicts components such as integrated circuits with specific manufacturer part numbers. It is to be understood that these components and their associated interconnects are not meant to be limiting in their disclosure, but rather, to provide one skilled in the art with the knowledge to make and use the present invention. Electronic components and interconnects may be substituted, modified, or replaced by one skilled in the art without detracting from the spirit and broad scope of the present invention as described by this specification and the appended claims.

Programming the biometric lockset is done through the keypad of the biometric lockset. A master code is used by the biometric lockset as a master password that authorizes changes to certain data contained in the biometric lockset. FIG. 9 is a flowchart showing a method of changing the master code of the Biometric Lockset. The steps to change the master code 900 of the biometric lockset begin with waking the lockset up by raising the slideway or pressing the * key once in step 901. This wake up procedure activates the electronics in the biometric lockset, which conserves limited battery power in the biometric lockset. In step 903, the sequence # # is entered in the keypad. In step 905, the preset master code is entered. This preset master code is the factory default, and may be, for example, 111111. Following step 905, the # key is pressed once, and the lockset returns a single beep in step 907. In step 909, the desired new master code is entered, followed by an entry of #. In step 911, the new master code is entered, followed by #. In step 913, the master code has been changed, and may be used for subsequent programming of the biometric lockset.

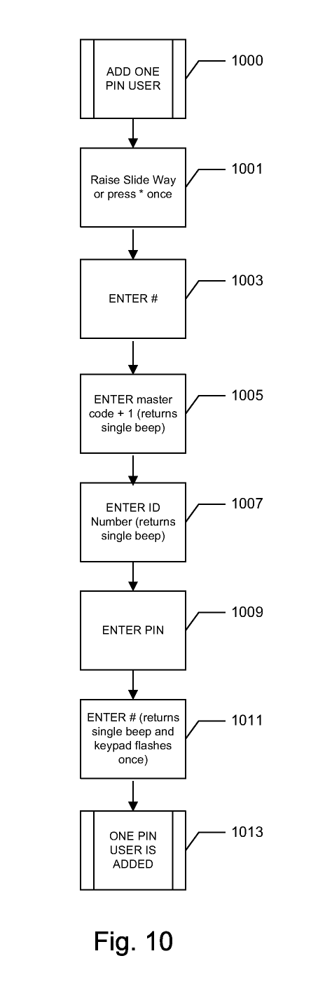

Referring now to FIG. 10, a flowchart showing a method of adding one PIN user to the Biometric Lockset is depicted. A PIN user is a user of the biometric lockset that activates the biometric lockset by way of a PIN (Personal Identification Number). It should be noted that an ID number is assigned to an individual, and may be associated with both their PIN number and their fingerprint template, or there may be a separate ID number for an individual's PIN number and an individual's fingerprint template. To add one PIN user in step 1000, the slideway is raised or the * key is pressed once in step 1001, waking up the biometric lockset. In step 1003, the # key is entered once. In step 1005, the master code is entered with the digit 1. The lockset returns a single beep. In step 1007, the ID number is entered, and the lockset returns a single beep. In step 1009, the PIN number is entered, and in step 1011, the # key is depressed, and the biometric lockset returns a single beep and the keypad flashes once, verifying that one PIN user has been added in step 1013.

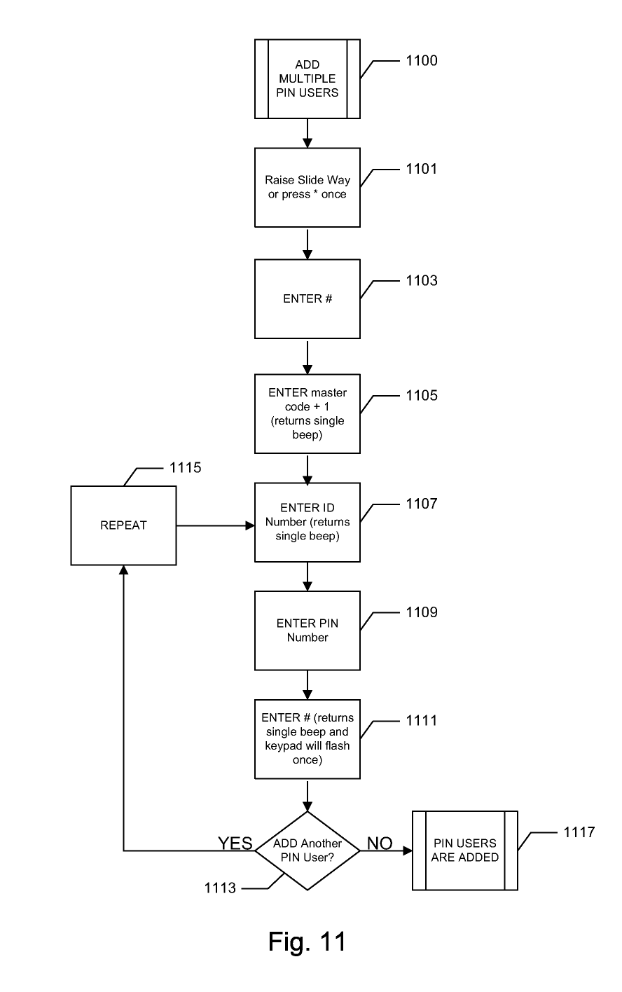

FIG. 11 depicts a flowchart showing a method of adding multiple PIN users to the Biometric Lockset. To add multiple PIN users to the biometric lockset in step 1100, the slideway is raised or the * key is pressed once in step 1101, waking up the biometric lockset. In step 1103, the # key is entered once. In step 1105, the master code is entered with the digit 1. The lockset returns a single beep. In step 1109, the PIN number is entered, and in step 1111, the # key is depressed, and the biometric lockset returns a single beep and the keypad flashes once, verifying that one PIN user has been added in step 1113. If the addition of another PIN user is desired in step 1113, steps 1107 through 1111 are repeated until such time as all PIN users are added in step 1117, and the process terminates.

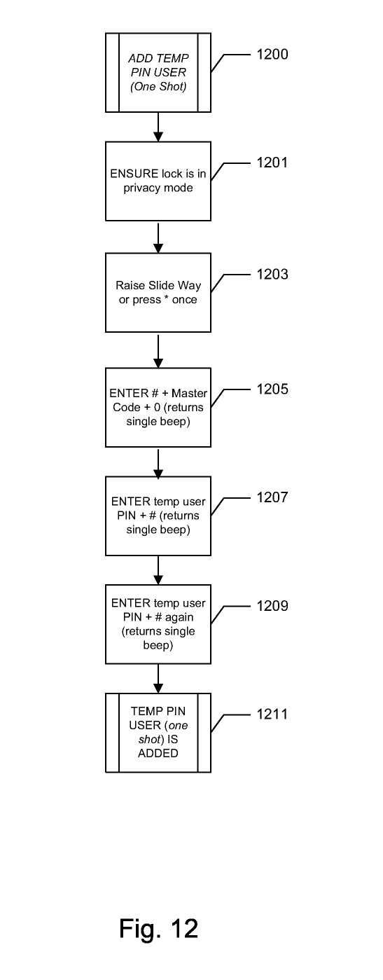

FIG. 12 shows a flowchart of a method of adding a temporary PIN user to the Biometric Lockset. This method allows a property owner, for example, to allow access by way of keypad data entry using a preset PIN number that unlocks the biometric lockset one time only, referred to herein as a “One Shot” entry. Once the biometric lockset is unlocked once with this temporary PIN number, the temporary PIN number is disabled from any further use. In step 1200, a temporary PIN user is established by ensuring that the biometric lockset is in privacy mode in step 1201, and then in step 1203, the slideway is raised or the * key is pressed once, waking up the biometric lockset. In step 1205, the # key is entered, and then the master code is entered, followed by the entry of a “0”. The biometric lockset then returns a single beep. In step 1207, a temporary user PIN number is entered, followed by entry of the # key. The biometric lockset returns a single beep. In step 1209, the temporary user PIN number is entered again, followed by entry of the # key. The biometric lockset returns a single beep. In step 1211, a temporary PIN user (one shot) has been added.

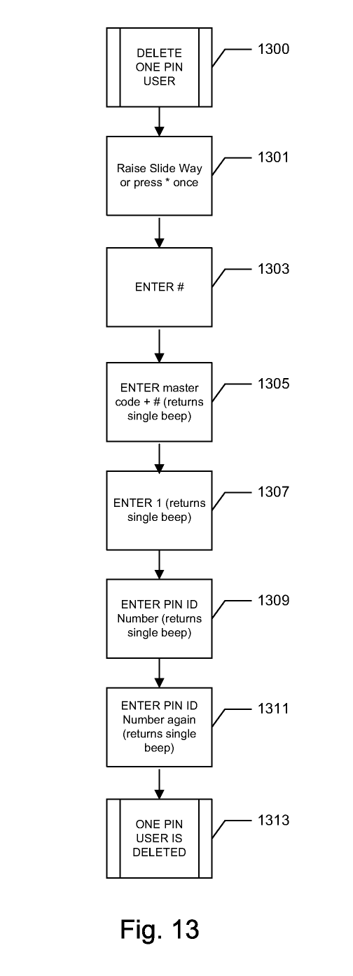

FIG. 13 is a flowchart showing a method of deleting one PIN user from the Biometric Lockset without effecting the entire database. In step 1300, the deletion of one PIN user is commenced by raising the slideway or entering the * key to wake up the biometric lockset in step 1301. In step 1303, the # key is entered, and in step 1305 the master code is entered followed by the entry of the # key. The biometric lockset returns a single beep. In step 1307 the 1 key is entered. The biometric lockset returns a single beep. In step 1309 the ID number to be deleted is entered. The biometric lockset returns a single beep. In step 1311 the ID number to be deleted is entered again. The biometric lockset returns a single beep again, and in step 1313 one user is deleted.

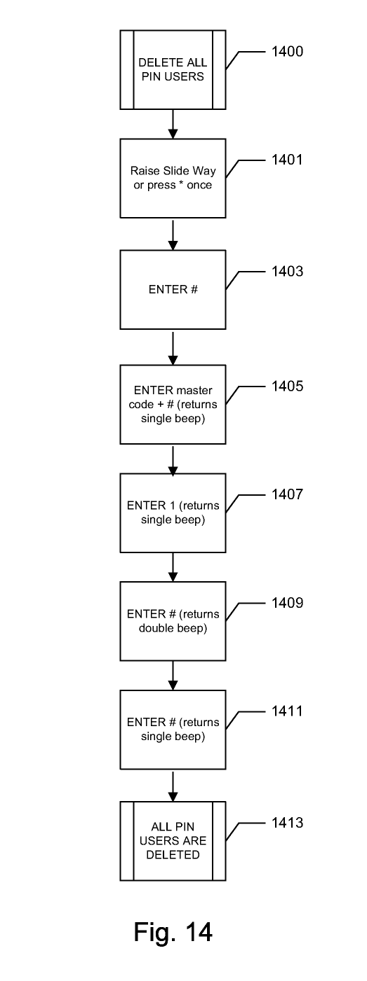

FIG. 14 shows a flowchart illustrating a method of deleting all PIN users from the Biometric Lockset. In step 1400 the process of deleting all PIN users is commenced by raising the slideway or entering the * key in step 1401 to wake up the biometric lockset. In step 1403, the # key is entered, and in step 1405 the master code is entered, followed by entry of the # key. The biometric lockset returns a single beep. In step 1407, the 1 key is depressed, and the biometric lockset returns a single beep. In step 1409, the # key is depressed, and the lockset returns a double beep. In step 1411, the # key is depressed, and the lockset returns a single beep, and in step 1413, all PIN users are deleted.

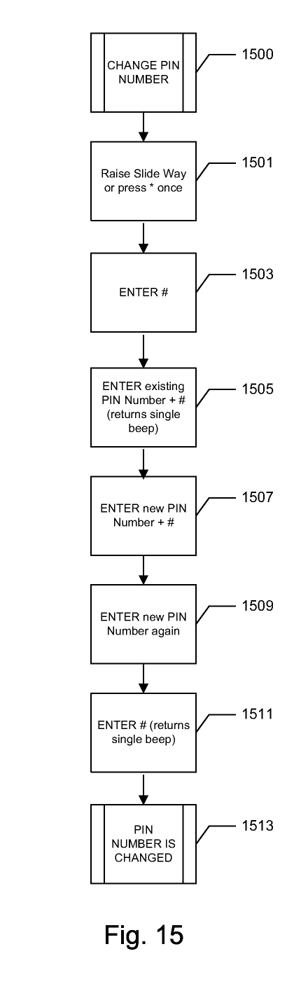

FIG. 15 depicts a flowchart showing a method of changing a PIN number in the Biometric Lockset. In step 1500 the process of changing a PIN number is commenced by raising the slideway or entering the * key in step 1501 to wake up the biometric lockset. In step 1503, the # key is entered, and in step 1505, an existing PIN number that one wishes to change is entered, followed by entry of the # key. The biometric lockset returns a single beep. In step 1507, a new PIN number is entered, followed by entry of the # key. In step 1509, the new PIN number is entered again, and in step 1511, the # key is entered. The biometric lockset returns a single beep, and in step 1513, the PIN number is changed.

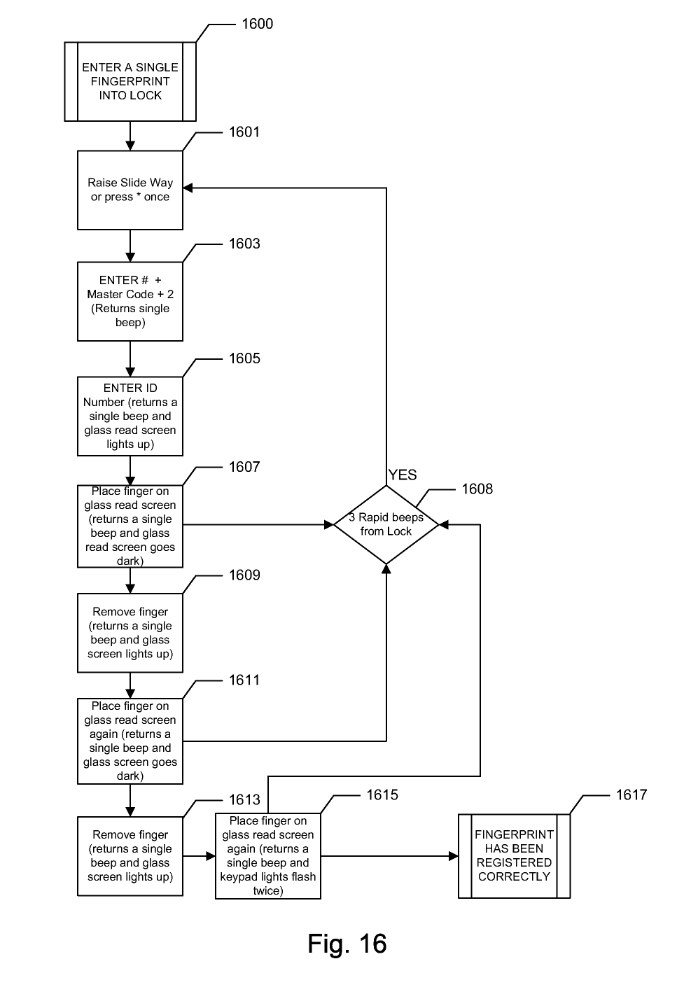

The remaining description of methods described by way of FIGS. 16 through 21 have to do with the addition, deletion, and use of the biometric fingerprint functionality of the biometric lockset. To enter a single fingerprint into the biometric lockset, one may turn to FIG. 16. Step 1600 commences the entry of a single fingerprint into the biometric lockset by raising the slideway or pressing the * key once in step 1601 to wake up the biometric lockset. In step 1603, the # key is depressed, followed by the master code, followed by entry of the digit 2. The biometric lockset will return a single beep. In step 1605, the biometric ID number is entered, and the biometric lockset returns a single beep and the glass read screen of the fingerprint sensor platen lights up. In step 1607, one places their finger on the glass read screen, and the biometric lockset returns a single beep and the glass read screen goes dark. In step 1609, one removes their finger from the glass read screen and the biometric lockset returns a single beep and the glass screen lights up. In step 1611, one places their finger on the glass read screen again, and the biometric lockset returns a single beep and the glass screen goes dark. In step 1613, one removes their finger from the glass read screen, and the biometric lockset returns a single beep and the glass screen lights up. In step 1615, one places their finger on the glass read screen again, and the biometric lockset returns a single beep and the keypad lights flash twice, indicating that the fingerprint has been correctly registered in step 1617. If at any time during fingerprint registration the biometric lockset returns 3 rapid beeps in step 1608, the registration process should be repeated starting at step 1601.

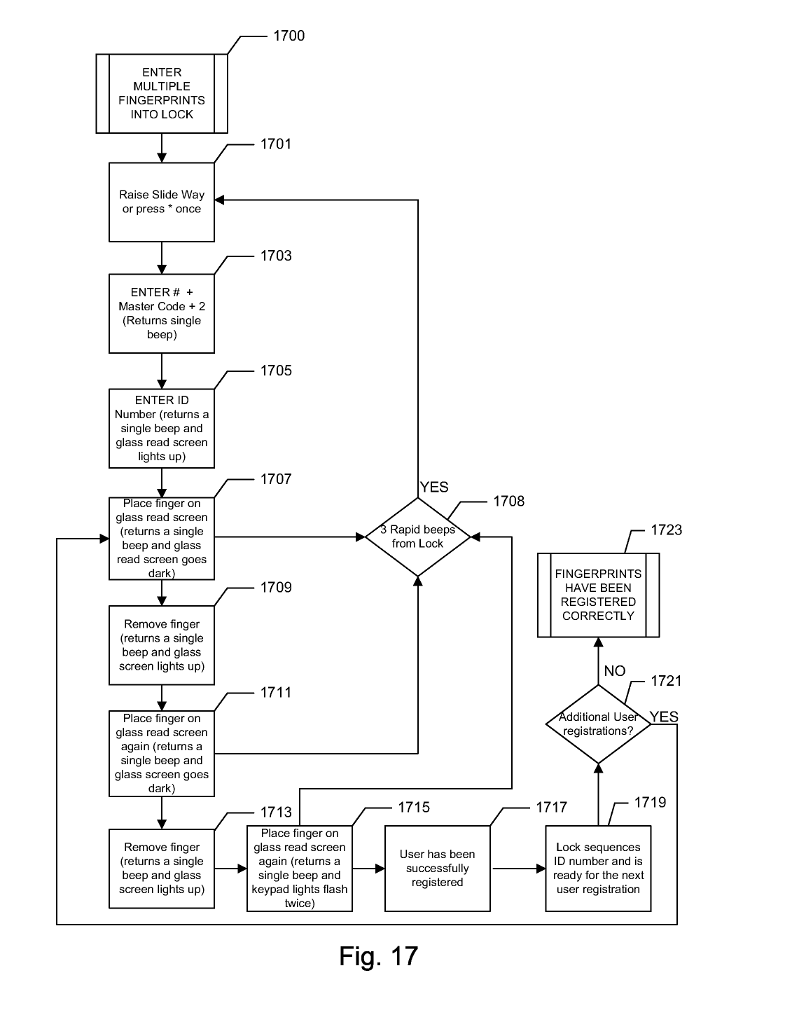

FIG. 17 is a flowchart showing a method of entering multiple fingerprints into the Biometric Lockset. To register multiple fingerprint users in a batch process, multiple fingerprints are entered in step 1700 by raising the slideway or pressing the * key once in step 1701. In step 1703, the # key is depressed, followed by the master code, followed by entry of the digit 2. The lockset returns a single beep. In step 1705, the biometric ID number is entered, and the lockset returns a single beep and the glass read screen lights up. In step 1707, one places their finger on the glass read screen, and the lockset returns a single beep and the glass read screen goes dark. In step 1709, one removes their finger from the glass read screen, and the biometric lockset returns a single beep and the glass read screen lights up. In step 1711, one places their finger on the glass read screen again, and the biometric lockset returns a single beep and the glass read screen goes dark. In step 1713, one removes their finger from the glass read screen, and the biometric lockset returns a single beep and the glass screen lights up. In step 1715, one places their finger on the glass read screen again, and the biometric lockset returns a single beep and the keypad lights flash twice, indicating that the user has been successfully registered in step 1717. In step 1719, the biometric lockset sequences the biometric ID number and is ready for the next user registration. In step 1721, if additional users are to be registered, the process repeats at step 1707. If, in step 1721, there are no additional user registrations, step 1723 ends the process with correctly registered fingerprints. If during the registration process, the biometric lockset sounds three rapid beeps in step 1708, the process should be repeated starting at step 1701.

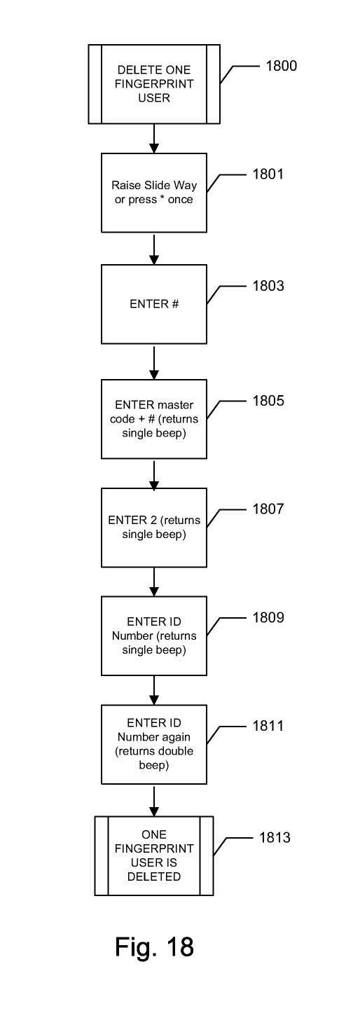

Referring now to FIG. 18, a flowchart showing a method of deleting one fingerprint user from the Biometric Lockset is shown. To commence deletion of one fingerprint user in step 1800, the slideway is raised or the * key is pressed once in step 1801. In step 1803, the # key is entered. In step 1805, the master code is entered, followed by entry of the # key, after which the biometric lockset returns a single beep. In step 1807, the digit 2 is entered, and the biometric lockset returns a single beep. In step 1809, the biometric ID number is entered, and the lockset returns a single beep. In step 1811, the biometric ID number is entered again, and the biometric lockset returns a double beep, and in step 1813, one fingerprint user is successfully deleted.

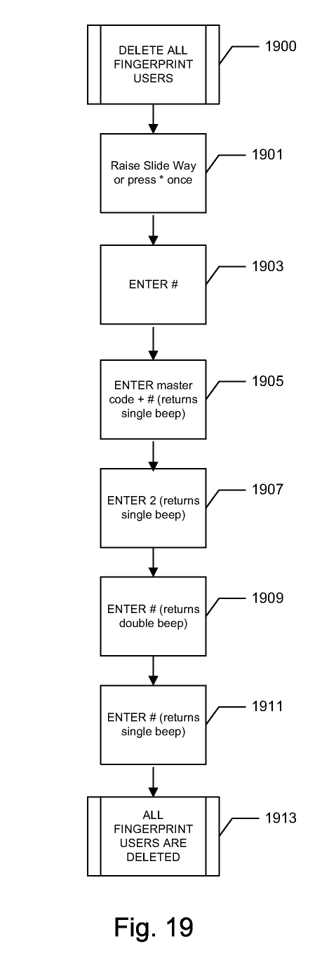

FIG. 19 depicts a flowchart showing a method of deleting all fingerprint users from the Biometric Lockset. To commence deletion of all fingerprint users in step 1900, the slideway is raised or the * key is pressed once in step 1901, waking up the biometric lockset. In step 1903, the # key is depressed, and in step 1905, the master code is entered, followed by entry of the # key. The biometric lockset returns a single beep. In step 1907, the digit 2 is entered, and the biometric lockset returns a single beep. In step 1909, the # key is depressed, and the biometric lockset returns a double beep. In step 1911, the # key is entered, and the biometric lockset returns a single beep, and in step 1913, all fingerprint users are deleted.

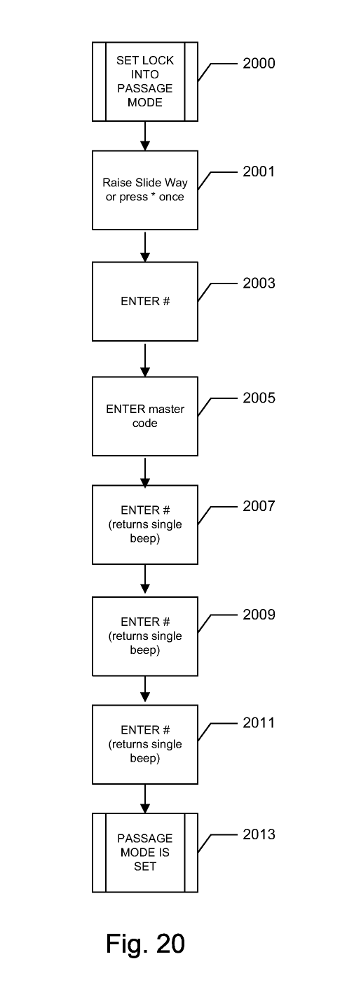

The biometric lockset can be placed into passage mode through multiple methods. Passage mode is the ability to open the lockset with one move of the handle and have the lockset stay in the unlocked state. To place the biometric lockset into passage mode, one can use biometric triggering through placement of their finger on the fingerprint sensor platen, or keypad entry, or activation of the inside lockset handle. FIG. 20 is a flowchart showing a method of setting the Biometric Lockset into Passage Mode. To commence placing the biometric lockset into passage mode in step 2000, the slideway is raised or the * key is depressed in step 2001, to wake up the biometric lockset. In step 2003, the # key is depressed. In step 2005, the master code is entered, and in step 2007, the # key is depressed. The biometric lockset returns a single beep. In step 2009, the # key is depressed, and the biometric lockset returns a single beep. In step 2011, the # key is depressed again, and the biometric lockset returns a single beep, and in step 2013, passage mode is set.

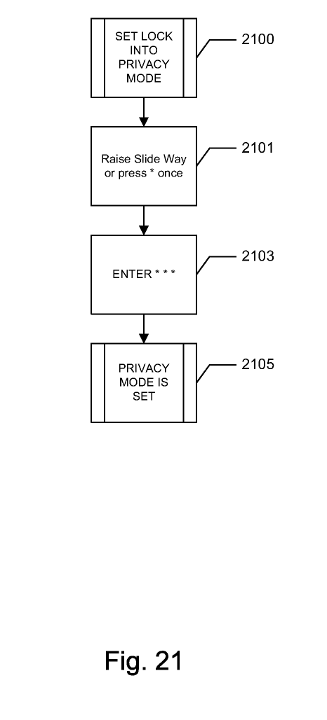

The biometric lockset can further be placed into privacy mode, which causes the door to be locked automatically after each valid opening. FIG. 21 is a flowchart showing a method of setting the biometric lockset into Privacy Mode. To commence setting the biometric lockset into privacy mode in step 2100, the slideway is raised once or the * key is entered in step 2101, waking up the biometric lockset. In step 2103, the * key is depressed three times, and privacy mode is set in step 2105.

The various programming methods, steps and sequences described by way of this specification and the drawings attached herein are meant to be provided by way of example, and not limitation. Various modifications to the programming methods, steps and sequences may be made by one skilled in the art without departing from the spirit and broad scope of the present invention as described by this specification and the appended claims.

It is, therefore, apparent that there has been provided, in accordance with the various objects of the present invention, a biometric lockset. While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A biometric lockset comprising:
a lockset body containing control circuitry wherein the control circuitry is operatively coupled to a fingerprint sensor;
a motor driven by the control circuitry and mechanically coupled to the lockset body; and
a slideway for covering the fingerprint sensor wherein the slideway contains a switch for activating the fingerprint sensor and control circuitry upon opening of the slideway to expose the fingerprint sensor.

2. The biometric lockset of claim 1 further comprising a slideway indent for facilitating opening and closing of the slideway.

3. The biometric lockset of claim 2 wherein the slideway indent contains a pattern of six squares configured in a matrix of 3 rows and 2 columns.

4. The biometric lockset of claim 1 further comprising a weather resistant seal placed between the slideway and the lockset body.

5. The biometric lockset of claim 1 further comprising a keypad for activating the biometric lockset and for sending commands to the biometric lockset.

6. The biometric lockset of claim 5 further comprising a cover for protecting the keypad of the biometric lockset.

7. The biometric lockset of claim 1 further comprising a mechanical keyway for locking and unlocking the biometric lockset.

8. The biometric lockset of claim 7 further comprising a keyway cover for covering the mechanical keyway.

9. The biometric lockset of claim 1 wherein the control circuitry includes a digital signal processor.

10. The biometric lockset of claim 1 further comprising a detent device for maintaining the slideway in an open position.

11. The biometric lockset of claim 1 wherein the fingerprint sensor uses optical technology.

12. The biometric lockset of claim 1 wherein the fingerprint sensor uses silicon technology.

13. The biometric lockset of claim 1 wherein the fingerprint sensor uses ultrasound technology.

14. The biometric lockset of claim 1 wherein the fingerprint sensor uses capacitive technology.

15. A slideway for protecting a fingerprint sensor of a biometric lockset comprising:
a cutaway for engaging with a biometric lockset body;
a slideway indent for facilitating opening and closing of the slideway on the biometric lockset;
a switch engaged between the slideway and the biometric lockset body for activating the biometric lockset;
a detent device for maintaining the slideway in an open position in relation to a biometric lockset upon which the slideway is attached; and
a weather resistant seal.

16. The slideway of claim 15 further comprising a cover for protecting a keypad of a biometric lockset.

17. The slideway of claim 15 wherein the slideway indent contains a pattern of six squares configured in a matrix of 3 rows and 2 columns.

18. A method for operating a biometric lockset comprising the steps of:
raising a slideway that covers a fingerprint sensor of the biometric lockset and activates the biometric lockset;
waiting for the fingerprint sensor to illuminate;
briefly placing a correct finger on the fingerprint sensor of the biometric lockset;
listening for a motor in the biometric lockset to engage; and
opening a door that contains the biometric lockset.

19. The method of claim 18 further including the step of closing the slideway upon successfully unlocking the biometric lockset.

20. The method of claim 18 further including the step of pressing a key on a keypad of the biometric lockset to activate the biometric lockset.
